(19) United States
(12) Patent Application Publication
(10) Pub. No.: US 2013/0000026 A1
(43) Pub. Date: Jan. 3, 2013

(54) VACUUM DRAIN UNCLOGGING APPARATUS

(75) Inventor: Roberto Gutierrez, El Paso, TX (US)

(73) Assignee: Inicia IP Holdings, LLC.

(21) Appl. No.: 13/534,290

(22) Filed: Jun. 27, 2012

Related U.S. Application Data
(60) Provisional application No. 61/502,392, filed on Jun. 29, 2011.

(51) Int. Cl. B08B 9/035

(52) U.S. Cl. 4/255.04

(57) ABSTRACT

An apparatus for clearing dogged drains using a vacuum. The drain unclogging apparatus includes a vacuum and a vacuum hose attached by a coupling sleeve attached to a long, flexible hose which is inserted into a dogged drain to the site of the dog. The apparatus may be used with the vacuum's negative pressure, or with the vacuum's positive pressure to achieve unclogging of a drain.

### CROSS-REFERENCE TO PROVISIONAL APPLICATION

This patent application claims the benefit under 35 U.S.C. §119(e) of U.S. Provisional Application Ser. No. 61/502,392 entitled, “Vacuum Drain Unclogging Apparatus,” which was filed on Jun. 29, 2011 and is incorporated herein by reference in its entirety.

### TECHNICAL HELD

Embodiments are generally related to solving plumbing problems and, more specifically, to an apparatus used to unclog drains using a vacuum.

### BACKGROUND OF THE INVENTION

Clogged or slow drains and sinks are a common household problem. Soap scum, dirt, grease, hair, and other waste often combine to create thick, stubborn obstructions in drain pipes, especially at the trap, or “elbow” of the drain. The most common remedies include caustic liquids and gels such as Drano, Liquid Plumr®, etc. These caustic mixtures are meant to chemically dissolve the clog to return the drain to working order. The corrosive nature of the chemical products makes them undesirable because of their environmental impact, potential damage to pipes and fixtures, and risk of illness or death if accidentally swallowed by children, pets, etc.

Numerous gadgets meant to mechanically pull clogs out of drains also exist. These gadgets are available for home use. Independently of how effective they may or may not be, they are messy and pose serious risk since they typically include barbs or hooks as part of their design. If they work, they still require that the user to deal with and dispose of the foul mess.

Additionally, devices of he “drain snake” type are available. Drain snakes are typically expensive and used mostly by professional plumbers, although some may be available for rent. Less costly products such as the Drainstick-Drain Clog Remover by Superior Tools and numerous others are available on the market. However, the common feature of all these products is that they require the mechanical removal of the clog, meaning lots of twisting, scraping, and pulling. If the drain is successfully unclogged, the user still has to dispose of the debris causing the clog, which is very messy.

Therefore, the need exists for an apparatus that the ordinary person can use to inexpensively remove clogs from drains without being subjected to disposing of the clogging material or tidying up after the drain has been unclogged. The present apparatus meets all of these needs.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved apparatus for unclogging dogged drains using a vacuum.

It is another aspect of the disclosed embodiments to provide for an apparatus for unclogging drains utilizing a coupling sleeve and a flexible hose.

The aforementioned aspect and other objectives and advantages can now be achieved as described herein. An apparatus for unclogging drains using a vacuum is disclosed. Such an apparatus includes a coupling sleeve and a long, flexible hose. In one embodiment, negative pressure from the vacuum may be utilized to achieve unclogging of a drain. In another embodiment, one or more coupling sleeves may be employed, along with a long, flexible hose, wherein positive pressure from the vacuum is utilized to assist in unclogging of the drain.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a vacuum drain unclogging apparatus that includes a long, flexible hose and a coupling sleeve, in accordance with an embodiment;

FIG. 2 illustrates a vacuum drain unclogging apparatus utilizing negative pressure from a vacuum, in accordance with an embodiment;

FIG. 3 illustrates a vacuum drain unclogging apparatus utilizing negative pressure from the vacuum inside a drain, in accordance with an alternative embodiment; and

FIG. 4 illustrates a view of a vacuum drain unclogging apparatus that functions with a “positive pressure” fitting, in accordance with an alternative embodiment.

### DETAILED DESCRIPTION

The particular values and configurations discussed in these non-limiting examples can be varied and are cited merely to illustrate at least one embodiment and are not intended to limit the scope thereof, Note that in FIGS, 1-3, identical or similar parts or elements are generally indicated by identical reference numerals.

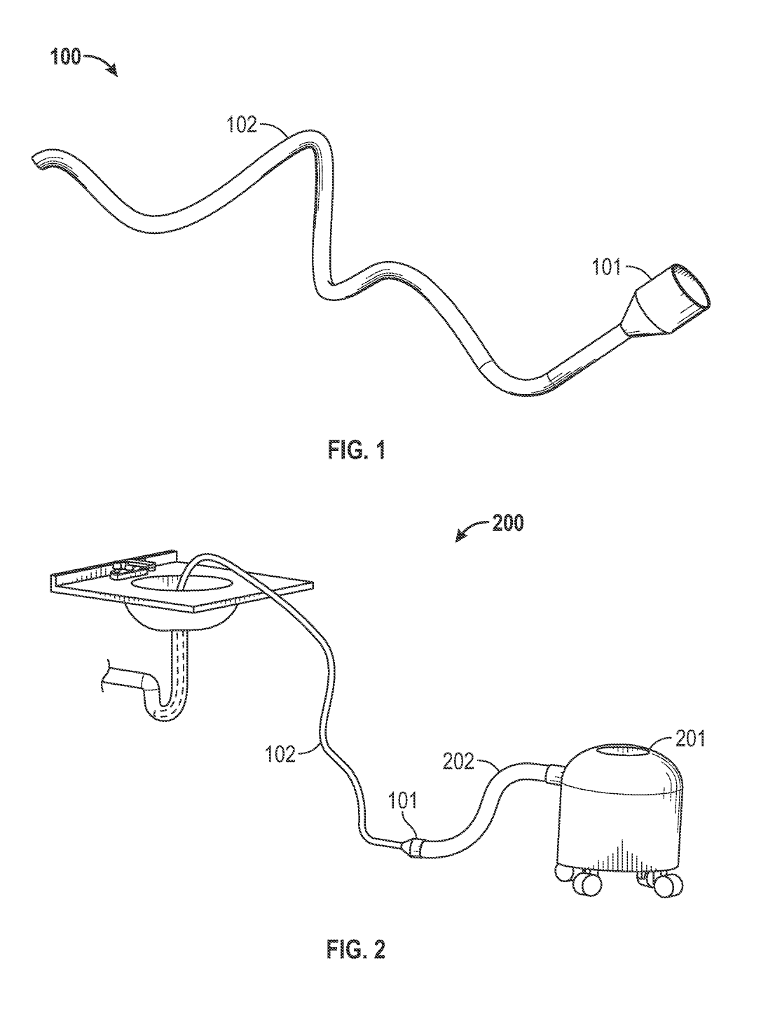

FIG. 1 illustrates a vacuum drain unclogging apparatus 100 that includes a flexible hose 102 and a coupling sleeve 101, in accordance with an embodiment. In the configuration shown in FIG. 1, the flexible hose 102 may be configured to possess varying lengths (e.g., a long hose, a medium-length hose, etc.). The flexible hose 102 connects to the coupling sleeve 101, which in turn is attached to a vacuum hose 202 (not shown in FIG. 1) of a vacuum 201 (not shown in FIG. 1). The flexible hose 102 of the apparatus 100 may be sized so as to fit easily and maneuver within a drain pipe while still being long enough to reach common clog sites such as the elbow of a drain pipe. The coupling sleeve 101 may be sized to attach easily to the vacuum hose 202 (shown in FIG. 2, but not FIG. 1).

FIG. 2 illustrates a vacuum drain unclogging system 200 utilizing the apparatus of FIG. 1 in association with negative pressure from a vacuum 201, in accordance with an embodiment. Note that in the system 200, the vacuum 201 may be one of numerous types commonly found in households, but also powerful enough for optimizing the effectiveness of the apparatus 100. For example, in some embodiments, vacuum 201 may be a shop vac. Additionally, a wet/dry vacuum can be well suited for use as vacuum 201 since clogs tend to contain moisture. In general, system 200 includes the vacuum 201 and its vacuum hose 202, which connects to the coupling sleeve 101, which in turn is connected to the long, flexible hose 102. The flexible hose 102 may then be inserted into a clogged drain to remove a clog.

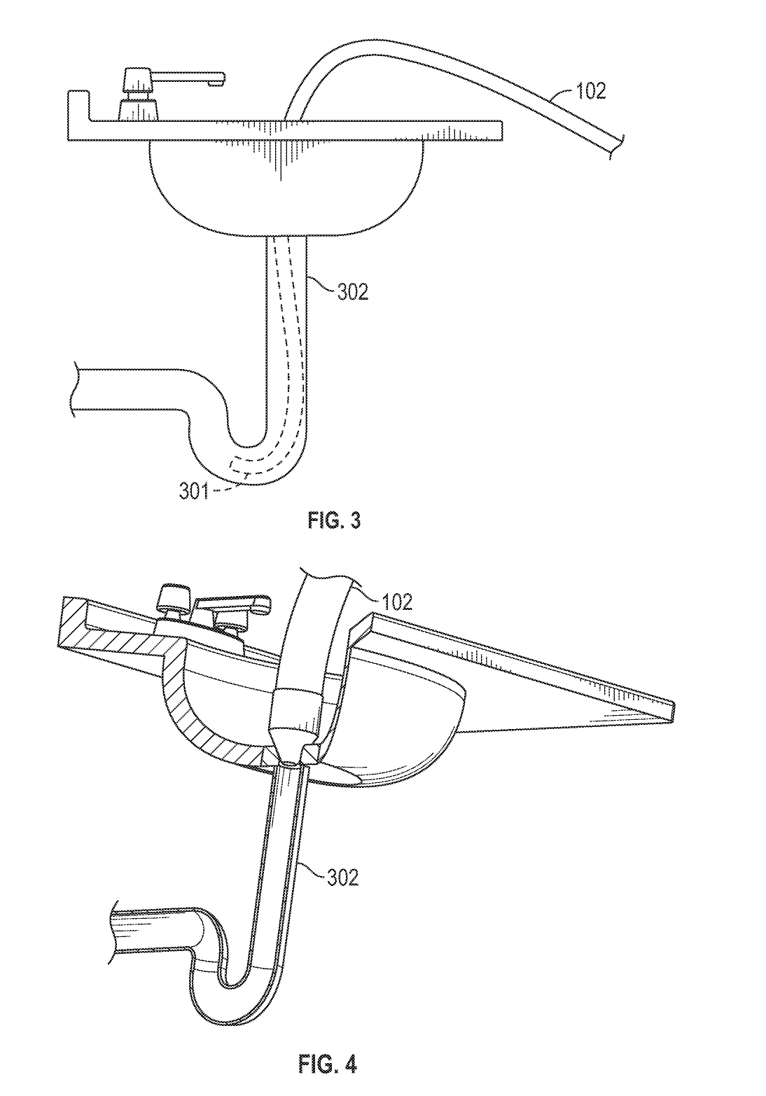

FIG. 3 illustrates a side view of the vacuum drain unclogging system 200 shown in FIG. 2 utilizing negative pressure from the vacuum 201 inside a drain 302, in accordance with an alternative embodiment. In general, the vacuum unclogging apparatus 100 may be inserted into the drain pipe 302 to the location of the clog 301. The powerful suction of the vacuum 201 clears away standing water and the clog 301. Minimal cleanup may be necessary in some situations after this procedure is complete, as all of the foul water and buildup clogging the drain has been vacuumed into the receptacle. Most importantly, no harsh chemicals or dangerous tools are required.

It should be understood that different embodiments of this apparatus may also be effective in clearing clogs. For example, the flexible hose may be outfitted with scraping or brushing tips to help dear the dog material. Additionally, hoses of different sizes may be utilized for different types of drains. For example, in one particular embodiment, the flexible hose may be, for example, a ½″×⅜″ dear vinyl tubing and coupled to a wet/dry shop vac.

In another embodiment, positive pressure may be utilized instead of a vacuum, when applicable. Rather than a thin flexible hose extending into the pipe, an arrangement of hose(s) 102 and coupling(s) 101 may be utilized to connect the “blower” output (exhaust) of the vacuum to the mouth of the clogged drain. The apparatus creates a seal at the mouth of the drain. The high positive pressure would then be used to dislodge the clog and allow it to flush down the drainpipe.

FIG. 4 illustrates a view of a vacuum drain unclogging apparatus that functions with a “positive pressure” fitting, in accordance with an alternative embodiment. As shown in FIG. 4, the same coupling sleeve from the vacuum embodiment described earlier can be utilized, but with the flexible hose removed. As before, it would fit over the end of the vacuum hose, but would be applied directly to (and create a seal over) the drain.

It will be appreciated that variations of the above disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. An apparatus for unclogging drains, said apparatus comprising:
a coupling sleeve that attaches to a vacuum via a vacuum hose connected to the vacuum; and
a flexible hose that attaches to said coupling sleeve, wherein said coupling sleeve and said flexible hose interact with one another to permit said flexible hose 10 insert into said drain for unclogging of said drain.

2. The apparatus of claim 1 wherein said flexible hose comprises varying diameters configured for effectiveness with respect to different types of drains.

3. The apparatus of claim 1 wherein said flexible hose comprises scraping tips attached to said flexible hose to aid in said unclogging of said drain.

4. An apparatus for unclogging drains, said apparatus comprising:
a coupling sleeve attached to a vacuum via a vacuum hose connected to said vacuum;
a flexible hose that attaches to said coupling sleeve; and
a second coupling sleeve that connects said flexible hose to a mouth of a drain, wherein said coupling sleeve, said flexible hose, and said second coupling sleeve interact with one another to permit said flexible hose to create a seal around said drain for unclogging of said drain.

5. The apparatus of claim 4 wherein said flexible hose comprises varying diameters.

6. The apparatus of claim 4 wherein said second coupling sleeve comprises varying diameters.
